(19) United States
(12) Patent Application Publication
(10) Pub. No.: US 2014/0065492 A1
(43) Pub. Date: Mar. 6, 2014

(54) SODIUM SECONDARY BATTERY ELECTRODE AND SODIUM SECONDARY BATTERY

(71) Applicants: Shinichi Komaba, Shinjuku-ku (JP); Naoaki Yabuuchi, Shinjuku-ku (JP); Wataru Murata, Toyama-shi (JP); Toru Ishikawa, Gamagori-shi (JP); Yuta Matsuura, Kikugawa-shi (JP); Satoru Kuze, Tsukuba-shi (JP)

(72) Inventors: Shinichi Komaba, Shinjuku-ku (JP); Naoaki Yabuuchi, Shinjuku-ku (JP); Wataru Murata, Toyama-shi (JP); Toru Ishikawa, Gamagori-shi (JP); Yuta Matsuura, Kikugawa-shi (JP); Satoru Kuze, Tsukuba-shi (JP)

(73) Assignee: SUMITOMO CHEMICAL COMPANY, LIMITED, Chuo-ku, Tokyo (JP)

(21) Appl. No.: 14/006,589

(22) PCT Filed: Mar. 19, 2012
(86) PCT No.: PCT/JP2012/057059

§ 371 Date: Nov. 15, 2013

(30) Foreign Application Priority Data
Mar. 24, 2011 (JP) 2011-066535
Oct. 12, 2011 (JP) 2011-225224

(51) Int. Cl. H01M 4/38; H01M 4/62; H01M 4/485

(52) U.S. Cl. CPC H01M 4/387; H01M 4/485; H01M 4/622; H01M 4/625; H01M 4/623
USPC 429/337; 429/231.9; 429/221; 429/223; 429/231.3; 429/224; 429/231.1; 429/231.2; 429/231.6; 429/324; 252/182.1; 252/503; 420/557

(57) ABSTRACT

The present invention provides an electrode that can be used for a sodium secondary battery having a larger discharge capacity when charging and discharging are performed repeatedly than that of the prior art. This sodium secondary battery electrode contains tin (Sn) powder as an electrode active material. The electrode, particularly, further contains one or more electrode-forming agents selected from the group consisting of poly(vinylidene fluoride) (PVDF), poly(acrylic acid) (PAA), poly(sodium acrylate) (PAANa), and carboxymethylcellulose (CMC), thereby making it possible to provide a sodium secondary battery having even greater electrode performance.

### TECHNICAL FIELD

The present invention relates to a sodium secondary battery electrode and a sodium secondary battery.

### BACKGROUND ART

As secondary batteries, lithium secondary batteries have already been put into practical use as compact electric sources for mobile phones, note PCs, etc., and can also be used as large-size electric sources such as automobile electric sources for electric vehicles and hybrid cars, and distributed electric sources for electric power storage, etc. Thus there is a growing demand for lithium secondary batteries.

However, the lithium secondary batteries require large quantities of materials containing expensive rare metal elements such as lithium in the production of component materials, and thus there is a concern for the supply of the above materials in coping with the growing demand for large-size electric sources.

In contrast, sodium secondary batteries are being investigated as secondary batteries that can resolve the above concern over material supply. In sodium secondary batteries, materials that are abundant in supply and inexpensive can be used as component materials. Thus, putting these materials in practical use, the supply of large-size electric sources in large quantities is being expected.

As the conventional sodium secondary battery, Patent Literature 1 specifically describes a sodium secondary battery that uses, as a positive-electrode active material, an inorganic sodium compound represented by a formula Na_{0.7}MnO_{2+y}, and, as a negative-electrode active material, tin (Sn) alone that was deposited by a sputtering device, etc., on an electricity collector as a thin film 2 μm thick and used as a negative electrode.

### CITATION LIST

### Patent Literature

Patent Literature 1: Kokai (Japanese Unexamined Patent Publication) No. 2006-216508

### SUMMARY OF INVENTION

### Problems to be Solved by the Invention

However, the sodium secondary battery disclosed in Patent Literature 1 is not sufficient in the performance as a secondary battery, i.e., its discharge capacity when charging and discharging are performed repeatedly is not sufficient.

While a Sn thin film is used as a negative-electrode active material therein, the active material layer is thin and thus the ratio of the active material relative to the volume of the electricity collector is small, which is unsuitable in fabricating batteries having a large discharge capacity per volume. Furthermore, since Sn has a large variation in volume during charging and discharging, performing charging and discharging repeatedly can cause the detachment of the active material, Sn thin film, from the electrode resulting in the decreasing tendency of discharge capacity.

Also, thin film-based electrodes required an extensive sputtering equipment, etc., that need vacuum equipment.

Under such circumstances, it is an object of the present invention to provide a sodium secondary battery electrode that can reduce the amount used of rare metals, has a large discharge capacity compared to conventional secondary battery electrodes, and does not easily cause reduction in discharge capacity when charging and discharging are performed repeatedly, and a sodium secondary battery employing the above electrode.

### Means to Solve the Problems

After intensive and extensive research to solve the above problems, the present inventors have arrived at the present invention.

The present invention provides the following inventions:

<1> A sodium secondary battery electrode, comprising a tin (Sn) powder as an electrode active material.

<2> The sodium secondary battery electrode according to the above <1>, further comprising an electrode-forming agent.

<3> The sodium secondary battery electrode according to the above <2>, wherein the electrode-forming agent is at least one selected from the group consisting of poly(vinylidene fluoride) (PVDF), poly(acrylic acid) (PAA), poly(sodium acrylate) (PAANa), and carboxymethylcellulose (CMC).

<4> The sodium secondary battery electrode according to any one of the above <1> to <3>, further comprising a carbonaceous material.

<5> A sodium secondary battery comprising a first electrode, a second electrode, and an electrolyte, wherein the first electrode is an the electrode according to any one of the above <1> to <4>, and the second electrode comprises an electrode active material selected from among a sodium metal, a sodium alloy, and a sodium compound capable of being doped and dedoped with a sodium ion.

<6> The sodium secondary battery according to the above <5>, wherein the electrode active material in the second electrode is made of an inorganic sodium compound.

<7> The sodium secondary battery according to the above <6>, wherein the inorganic sodium compound is an oxide represented by the following formula (A):

NaₓMO₂ (A)

where M is at least one element selected from the group consisting of Fe, Ni, Co, Mn, Cr, V, Ti, B, Al, Mg, and Si; and x is more than 0 and not more than 1.2.

<8> The sodium secondary battery according to any one of the above <5> to <7>, wherein the electrolyte comprises a nonaqueous electrolytic solution comprising an organic solvent and the nonaqueous electrolyte dissolved in the organic solvent, and the organic solvent comprises an organic solvent having a fluorine substituent.

<9> The sodium secondary battery according to the above <8>, wherein the organic solvent having a fluorine substituent is 4-fluoro-1,3-dioxolan-2-one.

### Effects of the Invention

In accordance with the present invention, a sodium secondary battery giving a larger discharge capacity can be provided, and furthermore the reduction in the discharge capacity when charging and discharging are performed repeatedly can be suppressed.

### MODE FOR CARRYING OUT THE INVENTION

### (1) Sodium Secondary Battery Electrode

The sodium secondary battery electrode of the present invention contains Sn powder as an electrode active material.

By containing Sn powder having a high Na absorption-desorption capacity as an electrode active material, the electrode of the present invention can enhance the discharge capacity per weight compared to the conventional carbon-based electrode active material. Also, while Sn as an electrode active material has a great variation in volume during Na absorption-desorption, Sn as an electrode active material of the present invention is in powdered form and therefore has an advantage that Sn separation from the electrode due to volume change, a problem associated with the use of Sn in a thin film form, may not easily occur.

### (1-1) Sn Powder

As Sn powder, there can be mentioned commercially available products manufactured by, for example, Wako Pure Chemical Industries (particle size: 45 μm, purity: 99.5%), Kojundo Chemical Laboratory (particle size: 38 μm, purity: 99.99%), Kanto Chemical (particle size: 45 μm), Merck (particle size: less than 71 μm), Nilaco (particle size: 150 μm, purity: 99.999%), and Aldrich (particle size: 150 nm, purity: 99.7%). Preferred is one manufactured by Aldrich, which has a smaller particle size.

As forms of Sn powder, there can be mentioned, for example, a thin film form, a globular form, a fibrous form, or an aggregate form of microparticles.

The average particle size of particles constituting Sn powder is preferably 0.01 μm to 30 μm, and more preferably 0.05 μm to 5 μm.

When the form of microparticles is not spherical, the length along the direction which represents the maximum length of the particle is considered as the particle size thereof.

The average particle size of Sn powder can be determined by arbitrarily sampling in units of 100 particles with a scanning electron microscope, and then measuring the particle size (diameter) to calculate the average value of particle size of 100 particles.

The content of Sn powder as an electrode active material for the sodium secondary battery electrode of the present invention is preferably 40% by weight or more.

As long as the effect of the present invention is not significantly ruined, the surface and/or part of the particles of Sn powder in the electrode may be oxidized.

Also, as long as the effect of the present invention is not significantly diminished, some of Sn powder in the electrode may be replaced with a metal element other than Sn, and the surface and/or part of the metal particles may be oxidized. The metal elements other than Sn include Na, Ti, Fe, Mn, Co, Ni, Ge, Pb, Sb, Bi or the like.

### (1-2) Electrode-Forming Agent

From the viewpoint of enhancing electrode performance, preferably the sodium secondary battery electrode of the present invention further contains an electrode-forming agent.

As the electrode-forming agent, at least one selected from the group consisting of poly(vinylidene fluoride) (PVDF), poly(acrylic acid) (PAA), poly(sodium acrylate) (PAANa), and carboxymethylcellulose (CMC) is preferably included.

For unknown reasons at present, the inclusion of these substances tends to enhance the discharge capacity.

Among them, poly(acrylic acid) (PAA) or poly(sodium acrylate) (PAANa) is preferred.

Since they act as a binder, they can obviate the need for or reduce the amount used of other binders.

The amount blended of the component materials in the electrode of the present invention is usually 0.5 to 50 parts by weight relative to 100 parts by weight of the Sn powder as the active material, preferably 1 to 30 parts by weight.

### (1-3) Carbonaceous Material

Preferably, the sodium secondary battery electrode of the present invention further has a carbonaceous material in addition to the Sn powder as the electrode active material and an electrode-forming agent.

By containing a carbonaceous material, the electrode performance can be further enhanced.

As the carbonaceous material, there can be mentioned, for example, pyrolytic carbons, and calcined organic materials. The carbonaceous material is preferably a non-graphitizable carbon (also referred to as “hard carbon”). Among them, carbon microbeads comprising a non-graphitizable carbon can be mentioned, and commercially available products thereof include, for example, ICB (trade name: NICABEADS) manufactured by Nippon Carbon Co., Ltd.

These carbonaceous materials also act as a conductive material. Thus, the inclusion of a carbonaceous material in the electrode can obviate the need for or reduce the amount used of other conductive materials.

As forms of particles constituting carbonaceous materials, there can be mentioned a thin film form as in naturally-occurring graphite, a globular form as in carbon microbeads, a fibrous form as in graphitizable carbon fibers, or an aggregate form of microparticles, and the like. The average particle size of particle forms constituting the carbonaceous material is preferably 0.01 μm to 30 μm, and more preferably 0.1 μm to 20 μm. When the form of microparticles is not spherical, the length along the direction which represents the maximum length of the particle is considered as the particle size thereof.

The average particle size of carbonaceous materials can be determined by arbitrarily sampling in units of 100 particles with a scanning electron microscope, and then measuring the particle size (diameter) to calculate the average value of particle size of 100 particles.

With regard to the amount blended of component materials in the electrode, the amount blended of a carbonaceous material is usually about 5 to 600 parts by weight relative to 100 parts by weight of the Sn powder as the active material, and preferably about 30 to 60 parts by weight.

### (1-4) Other Component Materials

The sodium secondary battery electrode of the present invention may include other component materials as needed in addition to the above component materials. Other component materials include, for example, a current collector, a binder, and a conductive material.

### (1-4-1) Current Collectors

The sodium secondary battery electrode of the present invention usually have a current collector.

As materials for the current collector, there can be mentioned, for example, metals such as nickel, aluminum, titanium, copper, gold, silver, platinum, aluminum alloy and stainless steel, for example those formed by plasma spraying or arc spraying a carbonaceous material, an activated carbon fiber, nickel, aluminum, zinc, copper, tin, lead or an alloy thereof, for example a conductive film in which a conductive material has been dispersed in a resin such as a rubber or a styrene-ethylene-butylene-styrene copolymer (SEBS), etc. As the forms of the current collector, there can be mentioned, for example, a foil form, a flat panel form, a mesh form, a net form, a lath form, and an embossed form as well as combinations thereof (for example, a mesh flat panel) and the like. Unevenness may be formed on the surface of a current collector by an etching process.

### (1-4-2) Binders

Binders have an effect of acting as a binder for adhering another component material for an electrode. When the electrode contains an electrode-forming agent mentioned above, a binder is used in cases where the amount added of an electrode-forming agent is insufficient and thus adhesion is inadequate.

As the binder, there can be mentioned a binder comprising an organic polymer compound. As organic polymer compounds as the binder, there can be mentioned, for example, polymers of fluorine compounds. As fluorine compounds, there can be mentioned, for example, fluorinated alkyl (the number of carbons: 1-18) (meth)acrylate, perfluoroalkyl (meth)acrylate [for example, perfluorododecyl (meth)acrylate, perfluoro n-octyl (meth)acrylate and perfluoro n-butyl (meth)acrylate], perfluoroalkyl substituted alkyl (meth)acrylate [for example, perfluorohexylethyl (meth)acrylate and perfluorooctylethyl (meth)acrylate], perfluorooxyalkyl (meth)acrylate [for example, perfluorododecyloxyethyl (meth)acrylate and perfluorododecyloxyethyl (meth)acrylate], fluorinated alkyl (the number of carbons: 1-18) crotonate, fluorinated alkyl (the number of carbons: 1-18) malate and fumarate, fluorinated alkyl (the number of carbons: 1-18) ithaconate, fluorinated alkyl substituted olefin (the number of carbons: about 2-10, the number of fluorine atoms: about 1-17), for example perfluorohexylethylene, fluorinated olefin having about 2-10 carbons and about 1-20 fluorine atoms in which fluorine atoms are bound to double bond carbons, tetrafluoroethylene, trifluoroethylene, hexafluoropropylene, and the like.

Other examples of binders include addition polymers of monomers comprising fluorine-free ethylenic double bonds. Examples of such monomers include (cyclo)alkyl (the number of carbons: 1-22) (meth)acrylate [for example, methyl (meth)acrylate, ethyl (meth)acrylate, n-butyl (meth)acrylate, iso-butyl (meth)acrylate, cyclohexyl (meth)acrylate, 2-ethylhexyl (meth)acrylate, isodecyl (meth)acrylate, lauryl (meth)acrylate, and octadecyl (meth)acrylate]; aromatic ring-containing (meth)acrylate [for example, benzyl (meth)acrylate, and phenylethyl (meth)acrylate]; mono(meth)acrylate of alkylene glycol or dialkylene glycol (the number of carbons of the alkylene group: 2-4) [for example, 2-hydroxyethyl (meth)acrylate, 2-hydroxypropyl (meth)acrylate, and diethyleneglycol mono(meth)acrylate]; (poly)glycerin (the degree of polymerization: 1-4) mono(meth)acrylate; (meth)acrylate-based monomers such as polyfunctional (meth)acrylate [for example, (poly)ethylene glycol (the degree of polymerization: 1-100) di(meth)acrylate, (poly)propylene glycol (the degree of polymerization: 1-100) di(meth)acrylate, 2,2-bis(4-hydroxyethylphenyl)propane di(meth)acrylate, and trimethylolpropane tri(meth)acrylate]; (meth)acrylamide-based monomers such as (meth)acrylamide, and (meth)acrylamide-based derivatives [for example, N-methylol (meth)acrylamide, and diacetone acrylamide]; cyano-group-containing monomers such as (meth)acrylonitrile, 2-cyanoethyl (meth)acrylate and 2-cyanoethyl acrylamide; styrenic monomers such as styrene and styrene derivatives having 7-18 carbons [for example, α-methylstyrene, vinyltoluene, p-hydroxystyrene, and divinylbenzene]; diene-based monomers such as alkadiene having 4-12 carbons [for example, butadiene, isoprene, and chloroprene]; alkenylester-based monomers such as carboxylic acid (the number of carbons: 2-12) vinylesters [for example, vinyl acetate, vinyl propionate, vinyl butyrate, and vinyl octanoate] and carboxylic acid (the number of carbons: 2-12) (meth)allylesters [for example, (meth)allyl acetate, (meth)allyl propionate, and (meth)allyl octanoate]; epoxy group-containing monomers such as glycidyl (meth)acrylate and (meth)allyl glycidyl ether; monoolefins such as monoolefins having 2-12 carbons [for example, ethylene, propylene, 1-butene, 1-octene and 1-dodecene]; monomers containing chlorine, bromine or iodine atoms, monomers containing a halogen atom other than fluorine such as vinyl chloride and vinylidene chloride; (meth)acrylic acids such as acrylic acid and methacrylic acid; monomers containing conjugated double bonds such as butadiene and isoprene, and the like. Also, addition polymers may be ethylene-vinyl acetate copolymers, styrene-butadiene copolymers or ethylene-propylene copolymers, etc. Carboxylic acid vinyl ester polymers may be partially or completely saponified as in polyvinyl alcohol. Conjugates may be copolymers of fluorine compounds and fluorine-free monomers containing ethylenic double bonds.

As other examples of binders, there can be mentioned, for example, polysaccharides and derivatives thereof such as starch, methylcellulose, hydroxymethyl cellulose, hydroxyethyl cellulose, hydroxypropyl cellulose, carboxymethyl hydroxyethyl cellulose, and nitrocellulose; phenol resins; melamine resins; polyurethane resins; urea resins; polyamide resins; polyimide resins; polyamideimide resins; petroleum pitch; coal pitch and the like. As binders, a plurality of binders may be used.

The amount blended of a binder as a component material in an electrode may usually be about 0.5 to 50 parts by weight relative to the total 100 parts by weight of the electrode active material, preferably about 1 to 30 parts by weight, while this may vary depending on the amount added of the above electrode-forming agent.

### (1-4-3) Conductive Materials

Conductive materials are used to enhance conductivity in the electrode. The above carbonaceous material may sometimes work as a conductive material.

As the conductive material, carbonaceous materials can be mentioned, and more specifically graphite powder, carbon black (for example, acetylene black, Ketjen black, and furnace black), fibrous carbonaceous materials (carbon nanotube, carbon nanofiber, vapor grown carbon fiber, etc.), etc., can be mentioned. Carbon black is tiny particles and have a large surface area. Thus, when a small amount of it is added to an electrode mixture, it can enhance conductivity of the interior of the electrode obtained, and can also enhance charge and discharge efficiency and the discharge property of a large electric current.

Usually, the ratio of a conductive material in the electrode mixture is 5 to 20 parts by weight relative to 100 parts by weight of the electrode active material. When the sodium secondary battery electrode of the present invention contains the above carbonaceous material, the ratio can be lowered.

### (1-5) Production Method

Hereinbelow, the method for producing a sodium secondary battery electrode of the present invention will be explained.

The sodium secondary battery electrode of the present invention is usually one in which an electrode mixture comprising Sn powder, a binder, etc., is supported on an electricity collector, and is usually in a sheet form. In this case, a method for producing an electrode include, for example,

(1) a method in which an electrode mixture paste obtained by adding a solvent to a mixture comprising Sn powder and, as needed, the above electrode-forming agent, a carbonaceous material, a binder, a conductive material, etc., is applied to or immersed in a current collector by the doctor blade method, and then dried;

(2) a method in which after a sheet obtained by adding a solvent to a mixture comprising Sn powder and, as needed, the above electrode-forming agent, a carbonaceous material, a binder, a conductive material, etc., followed by kneading, forming and drying to obtain a sheet, which is then joined onto the surface of a current collector via a conductive adhesive, etc., and then pressed and dried in a heat treatment; and

(3) a method in which after a mixture comprising Sn powder and, as needed, the above electrode-forming agent, a carbonaceous material, a binder, a conductive material, a liquid lubricant, etc., is formed on a current collector, the liquid lubricant is removed, and then the formed product in a sheet form obtained is monoaxially or multiaxially stretched. When the electrode is in a sheet form, the thickness is usually about 5 to 500 μm.

As solvents for use in the preparation of the electrode mixture paste, there can be mentioned, in addition to water, nonprotic polar solvents such as N-methylpyrrolidone; alcohols such as isopropyl alcohol, ethyl alcohol and methyl alcohol; ethers such as propylene glycol dimethylether; ketones such as acetone, methyl ethyl ketone, and methyl isobutyl ketone, and the like. In cases where a binder raises viscosity, a plasticizer may be used in order to facilitate the application to a current collector.

The method for applying an electrode mixture paste to a current collector is not specifically restricted. There can be mentioned, for example, slit die coating, screen coating, curtain coating, knife coating, gravure coating, and electrostatic spraying. Drying after coating may be performed by heat treatment, hot air drying, vacuum drying, etc. When heat treatment is used, the temperature is usually about 50 to 150° C. Drying may be followed by pressing. As the pressing method, there can be mentioned die pressing, roll pressing, and the like. The electrode of the present invention can be produced by the methods mentioned above.

### (2) Sodium Secondary Batteries

Next, the sodium secondary battery of the present invention will be explained.

The sodium secondary battery of the present invention is a sodium secondary battery having a first electrode, a second electrode and a nonaqueous electrolyte, wherein the first electrode is the above sodium secondary battery electrode of the present invention, and the second electrode is an electrode comprising an electrode active material selected from a sodium metal, a sodium alloy and a sodium compound capable of being doped and dedoped with a sodium ion. The sodium secondary battery of the present invention, usually, further has a separator.

The sodium secondary battery of the present invention is usually produced by housing an electrode group in a container such as a battery can, the electrode group being obtained by laminating and winding a first electrode, a separator and a second electrode, and allowing it to be impregnated with an electrolyte solution containing an electrolyte. The shape of a sodium secondary battery, which depends on the shape of the container, include, for example, a coin shape, a cylindrical shape, or a polygonal shape.

Hereinbelow, each constituting part of the sodium secondary battery of the present invention will be explained.

### (2-1) First Electrode

As a first electrode, the above sodium secondary battery electrode of the present invention will be used, and therefore its explanation will be omitted.

### (2-2) Second Electrode

The second electrode contains an electrode active material selected from a sodium metal, a sodium alloy, and a sodium compound capable of being doped and dedoped with a sodium ion.

The second electrode is composed of a current collector and an electrode mixture containing the above electrode active material supported on the current collector. The electrode mixture contains, as needed, a conductive material and a binder, in addition to the above electrode active material.

### (2-2-1) Electrode Active Material

The electrode active material of the second electrode comprises a sodium-containing material, and examples of the sodium-containing material include a sodium metal, a sodium alloy and a sodium compound capable of being doped and dedoped with a sodium ion.

As used herein, when the second electrode is a sodium metal or a sodium alloy, the first electrode acts as the positive electrode and the second electrode acts as the negative electrode. When the second electrode is a sodium compound capable of being doped and dedoped with a sodium ion, the first electrode acts as the negative electrode and the second electrode acts as the positive electrode. Whereas the sodium compound used can be any of an inorganic sodium compound and an organic sodium compound, an inorganic sodium compound is preferably used from the viewpoint of stability.

### (Inorganic Sodium Compound)

From the viewpoint of charge and discharge cycle characteristics of the sodium secondary battery obtained, an inorganic sodium compound is preferably used as the electrode active material of the second electrode. As the inorganic sodium compound, the following compounds can be mentioned:

oxides represented by NaM¹ₐ₁O₂ such as NaFeO₂, NaMnO₂, NaNiO₂ and NaCoO₂, oxides represented by Na_{0.44}Mn₁₋ₐ₂M¹ₐ₂O₂, and oxides represented by Na_{0.7}Mn₁₋ₐ₂M¹ₐ₂O_{2.05} (M¹ represents one or more transition metal elements, 0<a1<1, 0a2<1);

oxides represented by Na_{b}M²_{c}Si₁₂O₃₀ such as Na₆Fe₂Si₁₂O₃₀ and Na₂Fe₅Si₁₂O₃₀ (M² represents one or more transition metal elements, 2≦b≦6, 2≦c≦5);

oxides represented by Na_{d}M³ₑSi₆O₁₈ such as Na₂Fe₂Si₆O₁₈ and Na₂MnFeSi₆O₁₈ (M³ represents one or more transition metal elements, 2≦d≦6, 1≦e≦2);

oxides represented by Na_{f}M⁴₉Si₂O₆ such as Na₂FeSiO₆ (M⁴ represents one or more elements selected from a transition metal element, Mg and Al, 1≦f≦2, 1≦g≦2);

phosphates such as NaFePO₄, NaMnPO₄ and Na₃Fe₂(PO₄)₃;

fluorinated phosphates such as Na₂FePO₄F, Na₂VPO₄F, Na₂MnPO₄F, Na₂CoPO₄F and Na₂NiPO₄F;

fluorinated sulfates such as NaFeSO₄F, NaMnSO₄F, NaCoSO₄F and NaFeSO₄F;

borates such as NaFeBO₄ and Na₃Fe₂(BO₄)₃;

fluorides represented by NaₕM⁵F₆ such as Na₃FeF₆ and Na₂MnF₆ (M⁵ represents one or more transition metal elements, 2≦h≦3); and the like.

As the above inorganic sodium compound used herein, an oxide represented by the following formula (A) can preferably be used. By using an oxide represented by the following formula (A) as an electrode active material, specifically as a positive active material, the charge and discharge capacity of a battery can be enhanced.

NaₓMO₂ (A)

wherein, M represents at least one element selected from the group consisting of Fe, Ni, Co, Mn, Cr, V, Ti, B, Al, Mg and Si, and x is more than 0 and not more than 1.2.

The above oxide can be produced by calcining a mixture of metal-containing compounds that have a composition capable of being converted to oxides by calcination.

Specifically, after weighing and mixing the metal-containing compounds each containing a corresponding metal element to make a prescribed composition, the mixture obtained is calcined to produce an oxide. For example, an oxide having a metal element ratio represented by one preferred metal element ratio, Na:Mn:Fe:Ni=1:0.3:0.4:0.3, can be produced by weighing each raw material of Na₂CO₃, MnO₂, Fe₃O₄ and Ni₂O₃ to a molar ratio of Na:Mn:Fe:Ni=1:0.3:0.4:0.3, mixing them, and calcining the mixture obtained.

As metal-containing compounds that can be used in the production of an oxide for use in the present invention, there can be used oxides, as well as compounds that can be converted to oxides when decomposed and/or oxidized at high temperature, such as hydroxides, carbonates, nitrates, halides or oxalates. As sodium compounds, there can be mentioned one or more compounds selected from the group consisting of sodium hydroxide, sodium chloride, sodium nitrate, sodium peroxide, sodium sulfate, sodium bicarbonate, sodium oxalate and sodium carbonate, and hydrates thereof can also be mentioned. From the viewpoint of handling, sodium carbonate is more preferred. As manganese compounds, MnO₂ is preferred, as iron compounds, Fe₃O₄ is preferred, and as nickel compounds, Ni₂O₃ is preferred. These metal-containing compounds may be hydrates.

Mixtures of metal-containing compounds can also be obtained by obtaining a precursor by, for example, a coprecipitation method described below, and mixing the precursor obtained with a sodium compound mentioned above. Specifically, as a raw material for M (here, M is as described above), a chloride, a nitrate, an acetate, a formate, an oxalate, etc., can be dissolved in water, and then brought into contact with a precipitating agent to obtain a precipitate containing the precursor. Among the raw materials, a chloride is preferred. When a raw material which is hardly soluble in water is used, i.e., when an oxide, hydroxide or a metal material is used as a raw material, these materials can be dissolved in an acid such as hydrochloric acid, sulfuric acid and nitric acid or an aqueous solution thereof to obtain an aqueous solution containing M.

Furthermore, as the above precipitating agent, one or more compounds selected from the group consisting of LiOH (lithium hydroxide), NaOH (sodium hydroxide), KOH (potassium hydroxide), Li₂CO₃ (lithium carbonate), Na₂CO₃ (sodium carbonate), K₂CO₃ (potassium carbonate), (NH₄)₂CO₃ (ammonium carbonate) and (NH₂)₂CO (urea) can be used, or one or more hydrates of the above compounds may be used, or a compound and a hydroxide may be used in combination. It is also preferred that these precipitating agents be dissolved in water and used as aqueous solutions. The concentration of the above compounds in aqueous solutions of a precipitating agent is usually about 0.5 to 10 mol/L, preferably about 1 to 8 mol/L. Also, as the precipitating agent, KOH is preferably used, and more preferably an aqueous KOH solution in which KOH has been dissolved in water. As a precipitating agent in the form of aqueous solution, ammonium water can also be mentioned, and this may be used in combination with the above compound.

As a method for bringing a M-containing aqueous solution into contact with a precipitating agent, there can be mentioned one in which a precipitating agent (including an aqueous solution of the precipitating agent) is added to an aqueous solution containing M, one in which a M-containing aqueous solution is added to an aqueous solution of the precipitating agent, and one in which a M-containing aqueous solution and a precipitating agent (including an aqueous solution of the precipitating agent) are added to water. Stirring is preferably performed during these additions. Among the above contact methods, the one in which a M-containing aqueous solution is added to an aqueous solution of the precipitating agent can preferably be used since it is easy to maintain pH and control particle size. In this case, while pH tends to decrease as the M-containing aqueous solution is being added to an aqueous solution of the precipitating agent, it is preferred that the M-containing aqueous solution be added while controlling the pH at 9 or higher, preferably 10 or higher. The control can also be made by adding an aqueous solution of the precipitating agent.

By the above contact, a precipitated product can be obtained. The precipitated product contains a precursor.

After contact of the M-containing aqueous solution and the precipitating agent, a slurry is produced, which may be subjected to solid-liquid separation, and the precipitate can be recovered. While the solid-liquid separation can be made by any method, the solid-liquid separation by filtration, etc., is preferably used from the viewpoint of workability, and a method of spray-drying in which heating is followed by volatilization of the liquid component may also be used. Also, the precipitated product recovered may be washed or dried. While excess components of the precipitating agent may be attached to the precipitated product obtained after solid-liquid separation, the components can be reduced by washing. As a washing solution to be used in washing, water is preferably used, and an water-soluble organic solvent such as alcohol and acetone may also be used. Drying may be performed by heated drying, or by air drying or vacuum drying. When heated drying is used, the temperature is usually 50 to 300° C., preferably about 100 to 200° C. Alternatively, washing and drying may be performed twice or more.

While as a mixing method, any of dry mixing and wet mixing can be used, dry mixing is preferred from the viewpoint of simplicity. As mixing equipment, there can be mentioned a shaking mixer, a V-shaped mixer, a W-shaped mixer, a ribbon mixer, a drum mixer and a ball-mill. Calcination may be performed by maintaining the temperature usually at about 400 to 1200° C., preferably about 500 to 1000° C., while it depends on the type of the sodium compound used. The time for maintaining the above maintaining temperature is usually 0.1 to 20 hours, preferably 0.5 to 10 hours. The rate of temperature rise to the above maintaining temperature is usually 50 to 400° C./hour, and the rate of temperature decrease from the above maintaining temperature is usually 10 to 400° C./hour. While as the atmosphere for calcination, the atmospheric air, oxygen, nitrogen, argon or a mixed gas thereof can be used, the atmospheric air is preferred.

By using an appropriate amount of a halide such as a fluoride and a chloride as a metal-containing compound, the crystallinity of the oxide produced and the particle size of particles constituting the oxide can be controlled. In this case, a halide may sometimes act as a reaction promoter (flux). As a flux, there can be mentioned, for example, NaF, MnF₃, FeF₂, NiF₂, CoF₂, NaCl, MnCl₂, FeCl₂, FeCl₃, NiCl₂, CoCl₂, NH₄Cl and NH₄I. These compounds can be used as a raw material (metal-containing compound) of the mixture or used by adding an appropriate amount to the mixture. These fluxes may be hydrates.

As other metal-containing compounds, Na₂CO₃, NaHCO₃, etc., may be mentioned.

Also, flux other than the metal-containing compounds can be used, and for example B₂O₃, H₃BO₃, etc., may be mentioned.

When the above inorganic sodium compound is used as an electrode (positive electrode) active material in a sodium secondary battery electrode, it may be preferred that the inorganic sodium compound obtained as above be optionally pulverized using an industrially commonly used instrument such as a ball mill, a jet mill, and a shaking mill, followed by washing, sorting, etc., to control particle size. Calcining may be performed twice or more. Surface treatment such as coating the surface of the particles of an inorganic sodium compound with an inorganic substance containing Si, Al, Ti, Y or the like may be performed.

When the above surface treatment is followed by heat treatment, the BET specific surface area of the heat-treated powder may be smaller than the range of the BET specific surface area for the above inorganic sodium compound used in the present invention, though it depends on the temperature of the heat treatment.

### (2-2-2) Binder

As a binder for the second electrode, there can be mentioned a binder illustrated in the above sodium secondary battery electrode (first electrode) of the present invention. Also, the above electrode-forming agent can be used as a binder for the second electrode.

The ratio of the binder in the electrode mixture may usually be 5 to 20 parts by weight relative to 100 parts by weight of the electrode active material.

### (2-2-3) Conductive Material

As a conductive material for the second electrode, similarly to the above sodium secondary battery electrode (first electrode) of the present invention, a carbonaceous material can be mentioned, and more specifically, graphite powder, carbon black (for example, acetylene black, Ketjen black, furnace black, etc.), fibrous carbonaceous materials (carbon nanotube, carbon nanofiber, vapor grown carbon fiber, etc.), etc., can be mentioned. Carbon black is tiny particles and have a large surface area. When a small amount of it is added to an electrode mixture, it can enhance the conductivity inside the electrode obtained and can also enhance the charge and discharge efficiency and the discharge property of a large electric current. Usually, the ratio of a conductive material in the electrode mixture is 5 to 20 parts by weight relative to 100 parts by weight of the electrode active material. When the microparticles of carbonaceous materials and fibrous carbonaceous materials as above are used as a conductive material, the ratio can be lowered.

### (2-2-4) Method for Producing an Electrode Mixture Paste

A method for producing an electrode mixture paste for the second electrode will be explained. An electrode mixture paste for the second electrode can be obtained by kneading an electrode active material, a conductive material, a binder and an organic solvent. While the method of kneading is not specifically restricted, a mixer used in kneading is preferably one having a high shear stress. Specifically, there can be mentioned a planetary mixer, a kneader, an extrusion kneader, a thin-film high-speed stirrer, etc.

As a sequence of mixing, an electrode active material powder, a conductive material, a binder and a solvent may be mixed simultaneously, or a binder, an electrode active material powder and a conductive material may be sequentially added to a solvent. This sequence is not specifically restricted, and a mixture of an electrode active material powder and a conductive material may be added in portions or a solvent and a binder may be mixed and dissolved in advance.

The ratio of the electrode components in the above electrode mixture paste, i.e., the ratio of an electrode active material, a conductive material and a binder in the electrode mixture paste is usually 30 to 90% by weight, preferably 30 to 80% by weight, and more preferably 30 to 70% by weight from the viewpoint of the thickness and coatability of the electrode obtained.

The second electrode can be obtained by applying the above electrode mixture paste to an electricity collector and drying the product. By drying, the solvent in the electrode mixture paste can be removed, and the electrode mixture is bound to the electricity collector to yield an electrode.

### (2-2-5) Current Collector

In the second electrode, as a current collector, electric conductors such as Al, Ni, stainless steel, etc., can be mentioned, and, from the viewpoint of being easily worked to a thin film and being inexpensive, Al is preferred. As the forms of the current collector, there can be mentioned, for example, a foil form, a flat panel form, a mesh form, a net form, a lath form, a punching metal form, and an embossed form as well as combinations thereof (for example, a mesh flat panel) and the like. Unevenness may be formed on the surface of a current collector by etching process.

In producing a second electrode, the method for applying an electrode mixture paste to a current collector is not specifically restricted. There can be mentioned, for example, slit die coating, screen coating, curtain coating, knife coating, gravure coating, and electrostatic spraying. Drying after coating may be performed by heat treatment, hot air drying, vacuum drying, etc. When heat treatment is used, the temperature is usually about 50 to 150° C. Drying may be followed by pressing. As the pressing method, there can be mentioned die pressing, roll pressing, and the like.

The second electrode of the present invention can be produced by the methods mentioned above. The thickness of the electrode is usually about 5 to 500 μm.

### (3) Electrolyte

As an electrolyte that can be used in the sodium secondary battery of the present invention, there can be mentioned NaClO₄, NaPF₆, NaAsF₆, NaSbF₆, NaBF₄, NaCF₃SO₃, NaN(SO₂CF₃)₂, sodium salts of lower aliphatic carboxylic acids and NaAlCl₄, and mixtures of two or more thereof may also be used. Among them, it is preferred to use at least one selected from the group consisting of NaPF₆, NaAsF₆, NaSbF₆, NaBF₄, NaCF₃SO₃ and NaN(SO₂CF₃)₂.

The above electrolyte is usually dissolved in an organic solvent and used as a nonaqueous electrolyte. As an organic solvent, there can be used, for example, carbonates such as propylene carbonate, ethylene carbonate, dimethyl carbonate, diethyl carbonate, ethylmethyl carbonate, isopropanolmethyl carbonate, vinylene carbonate, 4-trifluoromethyl-1,3-dioxolan-2-one and 1,2-di(methoxycarbonyloxy)ethane; ethers such as 1,2-dimetoxyethane, 1,3-dimethxypropane, pentafluoropropylmethyl ether, 2,2,3,3-tetrafluoropropyl difluoromethylether, tetrahydrofuran, and 2-methyltetrahydrofuran; esters such as methyl formate, methyl acetate and γ-butyurolactone; nitriles such as acetonitrile and butyronitrile; amides such as N,N-dimethylformamide and N,N-dimethylacetamide; carbamates such as 3-methyl-2-oxazolidone; sulfur-containing compounds such as sulfolane, dimethyl sulfoxide and 1,3-propane sultone; or organic solvents having a fluorine-substituent in which a fluorine substituent has been introduced into the above organic solvents. As the organic solvent, two or more thereof may be used in a mixture.

As organic solvents having a fluorine substituent, there can be mentioned, for example, 4-fluoro-1,3-dioxolan-2-one (hereinafter referred to as FEC or fuluoroethylene carbonate), trans- or cis-4,5-difluoro-1,3-dioxolan-2-one (hereinafter referred to as DFEC or difluoroethylene carbonate).

An organic solvent having a fluorine substituent is preferably 4-fluoro-1,3-dioxolan-2-one.

While an organic solvent containing a fluorine substituent may be used alone, it is usually used in combination with another organic solvent having no fluorine substituent.

When an organic solvent having a fluorine substituent is contained in part of an organic solvent in the above nonaqueous electrolyte solution, the ratio of the organic solvent having a fluorine substituent relative to the entire nonaqueous electrolyte solution is 0.01% by volume to 10% by volume, preferably 0.1% by volume to 8% by volume, and more preferably 0.5% by volume to 5% by volume.

Also, in the sodium secondary battery of the present invention, the electrolyte can be used in a state where the above nonaqueous electrolyte solution is being retained in a polymer, i.e., as a gel electrolyte, or in a liquid state, i.e., as a solid electrolyte.

As a solid electrolyte, there can be used, for example, a polymer electrolyte such as a polyethylene oxide-based polymer, and a polymer containing at least one of a polyorganosiloxane chain or a polyoxyalkylene chain. A gel type can also be used in which a nonaqueous electrolyte solution was retained in a polymer. When using a sulfide electrolyte such as Na₂S—SiS₂, Na₂S—GeS₂, Na₂S—P₂S₅, and Na₂S—B₂S₃, or an inorganic electrolyte comprising a sulfide such as Na₂S—SiS₂—Na₃PO₄ and Na₂S—SiS₂—Na₂SO₄, and a NASICON type electrolyte such as NaZr₂(PO₄)₃, safety may be further enhanced.

When a solid electrolyte is used in the sodium secondary battery of the present invention, the solid electrolyte may play the role of a separator, in which case a separator may not be needed.

### (4) Separator

As a separator that can be used in the sodium secondary battery of the present invention, there can be used a material in the form of porous film, nonwoven fabric, woven fabric or the like made of a polyolefin resin such as polyethylene and polypropylene, a fluorine resin and a nitrogen-containing aromatic polymer. Two or more of these materials may be used to make a monolayer or laminated separator. As a separator, there can be mentioned, for example, one described in Kokai (Japanese Unexamined Patent Publication) No. 2000-30686, and Kokai (Japanese Unexamined Patent Publication) No. 10-324758. The thinner the thickness of the separator, the better, since it can enhance the volume energy density and reduce internal resistance as long as the mechanical strength can be maintained. Generally, the thickness of the separator is preferably about 5 to 200 μm and more preferably about 5 to 40 μm.

The separator preferably has a porous film comprising a thermoplastic resin. In a sodium secondary battery, when an abnormal current flows in the battery due to short circuit, etc., between the positive and negative electrodes, it is generally important to block the current to prevent (shut down) the passage of an excessively large current. Thus, when exceeding the normal use temperature, it is necessary that the separator shuts down at the lowest possible temperature (obstructs micropores when the separator has a porous film comprising a thermoplastic resin), and that even if the temperature in the battery rose to a certain high temperature after the shutdown, the separator maintains the shutdown state without film breakage at that temperature, in other words, has high temperature resistance. By using a separator comprising a laminated porous film in which a heat-resistant porous layer containing a heat-resistant resin and a porous film containing a thermoplastic resin are laminated as the separator, thermal breakage of the film can be prevented. The heat-resistant porous layer may be laminated on both sides of the porous film.

### (5) Uses

Since the sodium secondary battery of the present invention has a high discharge capacity, it can preferably be used as electric sources for compact appliances such as mobile phones, mobile audio players and notebook PCs, electric sources for transportation equipment such as automobiles, two-wheeled motor vehicles, electric wheelchairs, forklifts, trains, airplanes, ships, space ships and submarines, electric sources for agricultural machines such as cultivators, electric sources for outdoor activities such as camping, and electric sources for movable equipment such as automatic vendors.

Also, since the sodium secondary battery of the present invention as an electrode material can use abundant and inexpensive materials, it can preferably be used as stationary electric sources for plants, houses and outdoor equipment, load leveling electric sources for charging equipment for solar batteries, wind-power generation equipment and various power generation instruments, electric sources for low temperature and/or high temperature environments such as refrigerated and frozen storage warehouses, extremely cold places, deserts and outer space, electric sources for automatic doors, and the like.

### EXAMPLES

The present invention will now be explained with reference to specific examples, but it should not be construed that the present invention is restricted to them in any way.

### Example 1

### (Production of a Sodium Secondary Battery Electrode E¹)

Sn powder (manufactured by Aldrich, particle size: 150 nm, purity: 99.7%) as an electrode active material, acetylene black (manufactured by Denki Kagaku Kogyo Co., Ltd.) as a conductive material, and poly(vinylidene fluoride) (PVdF manufactured by Kureha Corporation, #1300) as an electrode-forming agent were each weighed to a composition ratio of electrode active material:conductive material:electrode-forming agent=8:1:1 (weight ratio). First the electrode-forming agent was added to an agate mortar, to which an appropriate amount of N-methyl-2-pyrrolidone (NMP: manufactured by Tokyo Chemical Industries, Co., Ltd.) as a solvent was added and fully mixed. After confirming the dissolution of the electrode-forming agent, the electrode active material and the conductive material were further added and fully mixed to obtain an electrode mixture paste. The electrode mixture paste obtained was applied on a copper foil using an applicator to the thickness of 100 μm, which was then placed in a drier, and fully dried, while removing the solvent, to obtain an electrode sheet. After this electrode sheet was fully pressed with a roll press, it was punched out with a diameter of 1.0 cm using an electrode punching press to obtain a sodium secondary battery electrode E¹.

### Example 2

### (Production of a Sodium Secondary Battery Electrode E²)

In a procedure similar to Example 1, except that PVdF was replaced with poly(acrylic acid) (PAA: manufactured by Sigma-Aldrich, molecular weight: 750,000) as the electrode-forming agent and ion-exchanged water as the solvent were used, a sodium secondary battery electrode E² was obtained.

### Example 3

### (Production of a Sodium Secondary Battery Electrode E³)

In a procedure similar to Example 1, except that PVdF was replaced with poly(sodium acrylate) (PAA: manufactured by Wako Pure Chemical Industries, molecular weight: 22,000 to 70,000) as the electrode-forming agent and ion-exchanged water as the solvent were used, a sodium secondary battery electrode E³ was obtained.

### Example 4

### (Production of a Sodium Secondary Battery Electrode E⁴)

In a procedure similar to Example 1, except that PVdF was replaced with carboxymethylcellulose (CMC: manufactured by Daiichi Kogyo Yakuhin, Cellogen 4H) as the electrode-forming agent and ion-exchanged water as the solvent were used, a sodium secondary battery electrode E⁴ was obtained.

### Example 5

### (Production of a Sodium Secondary Battery Electrode E⁵)

Sn powder (manufactured by Aldrich, particle size: 150 nm, purity: 99.7%) as an electrode active material, acetylene black (manufactured by Denki Kagaku Kogyo Co., Ltd.) as a conductive material, poly(vinylidene fluoride) (PVdF manufactured by Kureha Corporation, #1300) as an electrode-forming agent, and a commercially available non-graphitizable carbon as a carbonaceous material were each weighed to a composition ratio of electrode active material:conductive material:electrode-forming agent:carbonaceous material=4:1:1:4 (weight ratio). First the electrode-forming agent was added to an agate mortar, to which an appropriate amount of N-methyl-2-pyrrolidone (NMP: manufactured by Tokyo Chemical Industries, Co., Ltd.) as a solvent was added and fully mixed. After confirming the dissolution of the electrode-forming agent, the electrode active material, the conductive material and the carbonaceous material were further added and fully mixed to obtain an electrode mixture paste. The electrode mixture paste obtained was applied on a copper foil using an applicator to the thickness of 100 μm, which was then placed in a drier, and fully dried, while removing the solvent, to obtain an electrode sheet. After this electrode sheet was fully pressed with a roll press, it was punched out at a diameter of 1.0 cm using an electrode punching press to obtain a sodium secondary battery electrode E⁵.

### Example 6

### (Production of a Sodium Secondary Battery Electrode E⁶)

In a procedure similar to Example 5, except that PVdF was replaced with poly(acrylic acid) (PAA: manufactured by Wako Pure Chemical Industries) as the electrode-forming agent and ion-exchanged water as the solvent were used, a sodium secondary battery electrode E⁶ was obtained.

### Example 7

### (Production of a Sodium Secondary Battery Electrode E⁷)

In a procedure similar to Example 5, except that PVdF was replaced with poly(sodium acrylate) (PAA: manufactured by Wako Pure Chemical Industries, molecular weight: 22,000 to 70,000) as the electrode-forming agent and ion-exchanged water as the solvent were used, a sodium secondary battery electrode E⁷ was obtained.

### Example 8

### (Production of a Sodium Secondary Battery Electrode E⁸)

In a procedure similar to Example 5, except that PVdF was replaced with carboxymethylcellulose (CMC: manufactured by Daiichi Kogyo Yakuhin, Cellogen 4H) as the electrode-forming agent and ion-exchanged water as the solvent were used, a sodium secondary battery electrode E⁸ was obtained.

### (Fabrication of a Battery)

A coin battery was used in evaluating the above electrode. Onto the depression of the lower part of the coin battery (Hohsen Corporation), the above electrode as the first electrode was placed with the active material face facing upward, and 1M NaClO₄/propylene carbonate (manufactured by Kishida Chemical Co., Ltd.) as the electrolyte solution, a glass filter (manufactured by Advantec Co., Ltd., thickness: 38 μm) as the separator, and a sodium metal (manufactured by Kanto Kagaku Co., Ltd.) as the second electrode were combined to fabricate a battery. The fabrication of the battery was performed in an argon atmosphere in a glove box.

### (Evaluation of a Sodium Secondary Battery)

With regard to the charging and discharging conditions for the sodium secondary battery, charging was performed from the rest potential to 0 V at a CC (constant current) charging of 50 mA/g. Discharging was performed at a CC (constant current) discharging of 50 mA/g, and was cut off at a voltage of 1.5 V. The above charging and discharging were performed repeatedly for 10 cycles. As used herein charging indicates a process of doping (reduction) sodium ions to the active material of the first electrode, and discharging indicates a process of undoping (oxidation) sodium ions from the active material of the first electrode. Table 1 shows the discharge capacity at the fifth cycle of a sodium secondary battery fabricated using each of the sodium secondary battery electrodes E¹ to E⁸.

TABLE 1

| | | | Electrode mixture | |
|---|---|---|---|---|
| | | | ratio (Weight ratio) | |
| | | | (active material/ | Discharge |
| | | | electrode-forming | capacity |
| | | Electrode- | agent/conductive | at the |
| | | forming | material/carbonaceous | fifth cycle |
| | Electrode | agent | material) | [mAh/g] |
| Example 1 | Electrode E¹ | PVdF | 8/1/1/0 | 73.7 |
| Example 2 | Electrode E² | PAA | 8/1/1/0 | 124.6 |
| Example 3 | Electrode E³ | PAANa | 8/1/1/0 | 302.9 |
| Example 4 | Electrode E⁴ | CMC | 8/1/1/0 | 313.6 |
| Example 5 | Electrode E⁵ | PVdF | 4/1/1/4 | 269.9 |
| Example 6 | Electrode E⁶ | PAA | 4/1/1/4 | 485.5 |
| Example 7 | Electrode E⁷ | PAANa | 4/1/1/4 | 372.2 |
| Example 8 | Electrode E⁸ | CMC | 4/1/1/4 | 206.7 |

### Example 9

### (Fabrication of a Battery)

Onto the depression of the lower part of a coin battery (Hohsen Corporation), the electrode E² fabricated in the above Example 2 was placed with the active material face facing upward, and a mixed solution of 1M NaClO₄/ethylene carbonate (manufactured by Kishida Chemical Co., Ltd.) and 4-fluoro-1,3-dioxolan-2-one (manufactured by Kishida Chemical Co., Ltd.) mixed at 98:2 (volume ratio) was used as the electrolyte solution, and a glass filter (manufactured by Advantec Co., Ltd., thickness: 38 μm) as the separator and a sodium metal (manufactured by Kanto Kagaku Co., Ltd.) as the second electrode were combined to fabricate a battery B⁹. The fabrication of the battery was performed in an argon atmosphere in a glove box.

### (Evaluation of a Sodium Secondary Battery)

With regard to the charging and discharging conditions for the sodium secondary battery, charging was performed from the rest potential to 0 V at a CC (constant current) charging of 50 mA/g. Discharging was performed at a CC (constant current) discharging of 50 mA/g, and was cut off at a voltage of 1.2 V. The above charging and discharging were performed repeatedly for 10 cycles. As used herein charging indicates a process of doping (reduction) sodium ions to the active material of the first electrode, and discharging indicates a process of undoping (oxidation) sodium ions from the active material of the first electrode. Table 2 shows the discharge capacity at the fifth cycle of the sodium secondary battery B⁹.

### Example 10

In a procedure similar to Example 9, except that a mixed solution of 1M NaClO₄/(ethylene carbonate:diethyl carbonate=1:1 (volume ratio)) (manufactured by Kishida Chemical Co., Ltd.) and 4-fluoro-1,3-dioxolan-2-one (manufactured by Kishida Chemical Co., Ltd.) mixed at 98:2 (volume ratio) was used as the electrolyte solution, a battery B¹⁰ was fabricated, and the sodium secondary battery was evaluated. Table 2 shows the discharge capacity at the fifth cycle of the sodium secondary battery B¹⁰.

### Example 11

With regard to the sodium secondary battery B¹¹ similar to the sodium secondary battery B⁹ fabricated in the above Example 9, charging was performed from the rest potential to 0 V at a CC (constant current) charging of 50 mA/g. Discharging was performed at a CC (constant current) discharging of 50 mA/g, and was cut off at a voltage of 0.8 V. The above charging and discharging were performed repeatedly for 30 cycles. As used herein charging indicates a process of doping (reduction) sodium ions to the active material of the first electrode, and discharging indicates a process of undoping (oxidation) sodium ions from the active material of the first electrode. Table 2 shows the discharge capacity at the 5th and 20th cycles of the sodium secondary battery B¹¹.

### Example 12

With regard to the sodium secondary battery B¹² similar to the sodium secondary battery B¹⁰ fabricated in the above Example 10, the sodium secondary battery was evaluated at the same charging and discharging conditions as that of Example 11. Table 2 shows the discharge capacity at the 5th and 20th cycles of the sodium secondary battery B¹².

### Example 13

In a procedure similar to Example 9, except that 1M NaClO₄/propylene carbonate (manufactured by Kishida Chemical Co., Ltd.) was used as the electrolyte solution, a battery B¹³ was fabricated, and the sodium secondary battery was evaluated.

Charging was performed from the rest potential to 0 V at a CC (constant current) charging of 50 mA/g. Discharging was performed at a CC (constant current) discharging of 50 mA/g, and was cut off at a voltage of 0.8 V. The above charging and discharging were performed repeatedly for 10 cycles. As used herein charging indicates a process of doping (reduction) sodium ions to the active material of the first electrode, and discharging indicates a process of undoping (oxidation) sodium ions from the active material of the first electrode. Table 2 shows the discharge capacity at the 5th cycle of the sodium secondary battery B¹³.

### Example 14

In a procedure similar to Example 9, except that 1M NaClO₄/ethylene carbonate (manufactured by Kishida Chemical Co., Ltd.) was used as the electrolyte solution, a battery B¹⁴ was fabricated, and the sodium secondary battery was evaluated. Table 2 shows the discharge capacity at the 5th cycle of the sodium secondary battery B¹⁴.

TABLE 2

| | | | | Upper limit | Discharge | Discharge |
|---|---|---|---|---|---|---|
| | | | Solvent for | voltage at | capacity | capacity |
| | | | electrolyte | discharging | at 5th cycle | at 20th cycle |
| | Battery | Electrode | solution | [V] | [mAh/g] | [mAh/g] |
| Example 9 | Battery B⁹ | Electrode E² | EC/FEC | 1.2 | 460.2 | — |
| Example 10 | Battery B¹⁰ | Electrode E² | EC/DEC/FEC | 1.5 | 498.9 | — |
| Example 11 | Battery B¹¹ | Electrode E² | EC/FEC | 0.8 | 441.3 | 367.8 |
| Example 12 | Battery B¹² | Electrode E² | EC/DEC/FEC | 0.8 | 470.3 | 489.1 |
| Example 13 | Battery B¹³ | Electrode E² | PC | 0.8 | 436.1 | — |
| Example 14 | Battery B¹⁴ | Electrode E² | EC | 0.8 | 654 | — |

### INDUSTRIAL APPLICABILITY

Since, in the sodium secondary battery electrode of the present invention, a active material layer having a sufficient thickness can be formed, the greater ratio of the amount of the active material relative to the volume of the current collector can be attained, and thus it becomes possible to fabricate a battery having a large discharge capacity per volume.

Furthermore, the battery of the present invention can be formed with inexpensive materials without using an expensive rare metal element of lithium, and thus the present invention is industrially very useful.

Also, in accordance with the present invention, an electrode can be easily fabricated in an atmosphere of the air without using sputtering instrument, etc., that require extensive vacuum equipment, etc., and thus the present invention is industrially very useful.

1. A sodium secondary battery electrode, comprising a tin (Sn) powder as an electrode active material.

2. The sodium secondary battery electrode according to claim 1, further comprising an electrode-forming agent.

3. The sodium secondary battery electrode according to claim 2, wherein the electrode-forming agent is at least one selected from the group consisting of poly(vinylidene fluoride) (PVDF), poly(acrylic acid) (PAA), poly(sodium acrylate) (PAANa), and carboxymethylcellulose (CMC).

4. The sodium secondary battery electrode according to claim 1, further comprising a carbonaceous material.

5. A sodium secondary battery comprising a first electrode, a second electrode, and an electrolyte, wherein the first electrode is the electrode according to claim 1, and the second electrode comprises an electrode active material selected from among a sodium metal, a sodium alloy, and a sodium compound capable of being doped and dedoped with a sodium ion.

6. The sodium secondary battery according to claim 5, wherein the electrode active material in the second electrode is made of an inorganic sodium compound.

7. The sodium secondary battery according to claim 6, wherein the inorganic sodium compound is an oxide represented by the following formula (A):
NaₓMO₂ (A)
where M is at least one element selected from the group consisting of Fe, Ni, Co, Mn, Cr, V, Ti, B, Al, Mg, and Si; and x is more than 0 and not more than 1.2.

8. The sodium secondary battery according to claim 5, wherein the electrolyte comprises a nonaqueous electrolytic solution comprising an organic solvent and the nonaqueous electrolyte dissolved in the organic solvent, and the organic solvent comprises an organic solvent having a fluorine substituent.

9. The sodium secondary battery according to claim 8, wherein the organic solvent having a fluorine substituent is 4-fluoro-1,3-dioxolan-2-one.
